(19) United States
(12) Patent Application Publication
(10) Pub. No.: US 2011/0202930 A1
(43) Pub. Date: Aug. 18, 2011

(54) RESOURCE EXCLUSION CONTROL METHOD AND EXCLUSION CONTROL SYSTEM IN MULTIPROCESSORS AND TECHNOLOGY ASSOCIATED WITH THE SAME

(75) Inventor: Shoichi Araki, Kyoto (JP)

(73) Assignee: PANASONIC CORPORATION, Osaka (JP)

(21) Appl. No.: 13/095,557

(22) Filed: Apr. 27, 2011

Related U.S. Application Data
(63) Continuation of application No. PCT/JP2009/003378, filed on Jul. 17, 2009.

(30) Foreign Application Priority Data
Nov. 7, 2008 (JP) 2008-286401

(51) Int. Cl. G06F 9/46

(52) U.S. Cl. 718/106

(57) ABSTRACT

When locking of a lock object by a process is attempted, whether the locking succeeded is determined. Having determined that the locking succeeded, the process is executed at a relatively high processing speed in an interval during which the locking is valid as compared to an interval during which the locking is invalid.

### FIELD OF THE INVENTION

The present invention relates an exclusion control method and an exclusion control system for using a sharable resource when a plurality of processes is executed in parallel by a plurality of processors, and further to a hard disc recorder and a mobile terminal associated with the exclusion control technique.

### BACKGROUND OF THE INVENTION

The entire documents of Japanese patent application No. 2008-286401 filed on Nov. 7, 2008, which include the specification, drawings, and scope of claims, are incorporated herein by reference.

When a resource is jointly used by different processes in a multiprocessor where the processes are being executed in parallel by a plurality of processors, exclusion control of the resource is a necessary step to guarantee a consistency between the processes. The exclusion control allows the processes to use the resource exclusively, and an interval during which the exclusion control is necessary is hereinafter called an exclusion control interval.

Conventionally, process switching or interrupt is prohibited during the exclusion control interval to exclusively control the use of a resource between different processes executed by a processor, so that a consistency between the processes is guaranteed. To exclusively control the use of a resource between a plurality of processes executed by different processors, a lock object corresponding to the resource is acquired (locking) or released (unlocking) to avoid concurrent execution of the processes during the exclusion control interval, so that a consistency between the processes is guaranteed. In such an exclusion control, the exclusion control interval may be called a locking interval.

Below is described a resource exclusion control method for a multiprocessor system wherein a lock object is used. FIG. 13 is a flow chart illustrating conventional processing steps for acquiring a lock object (locking). Before the exclusion control starts in the exclusion control interval, a lock object acquiring (locking) process is invoked, and exclusion control processing steps described below are executed.

In Step S1, locking status information of the lock object is acquired. In Step S2, locking of the lock object is attempted. In Step 3, whether the locking succeeded is determined. In the case where the locking failed, meaning that the lock object is already locked based on the information acquired in Step S1 (already acquired by any other process), the exclusion control process returns to Step S1. When the locking succeeded, meaning that the lock object is still unlocked (not yet acquired by any other process), the exclusion control process ends.

A requirement of the exclusion control is to inseparably carry out Step S1 and Step S2 as a sequence of processing steps (atomic operation). Having determined in Step S3 that the lock object is already locked based on the information obtained in Step S1, the exclusion control process returns to Step S1. The return to the processing step is called “busy waiting” or “spinlock”.

FIG. 14 is a flow chart of conventional processing steps for releasing the lock object (unlocking). Before the exclusion control ends in the exclusion control interval, a lock object releasing (unlocking) process is invoked. In Step S31, the lock object is unlocked, and the releasing process ends. S31 is a part of a sequence of processing steps alongside Steps S1 and S2 to be inseparably executed.

There is a conventional technique described below which was developed to prevent a throughput from deteriorating whenever any process that failed to acquire a lock object busy-waits all the time in consequence of competitive accesses to a sharable resource. When a process which intends to use a resource acquires a lock object corresponding to the resource, the lock object is locked. Therefore, a different process which similarly intends to acquire the same lock object is unable to proceed for the time being, and the process which failed to acquire the lock object has to busy-wait or sleep until the process which acquired the lock object releases the acquired lock object. Describing the busy waiting, a process in execution within a short loop waits for the lock object to be released. Describing the sleep, a process which failed to acquire the lock object surrenders a right of execution by a processor for process switching to any other executable process.

There are the following two perspectives in improving a whole system throughput. When a length of time for the lock object to be released is larger than a process switch overhead, any process that failed to acquire the lock object sleeps, making it more advantageous to assign the processor to any other process. When the length of time until for the lock object to be released is smaller than the process switch overhead, on the other hand, any process that failed to acquire the lock object does not sleep, making it more advantageous to continue to wait for the lock object to be released while busy waiting.

The process which failed to acquire the lock object finds a different process which succeeded in acquiring the lock object to check whether the process is in execution. If the checked process is currently in execution, the process which failed to acquire the lock object waits for the lock object to be released. If the checked process is currently not in execution, the process determines that the length of time for the lock object to be released is larger than the process switch overhead and then sleeps, surrendering the processor to any other process. Such a technique can consequently improve the whole system throughput (see the Patent Document 1).

### PRIOR ART DOCUMENT

### Patent Document

Patent Document 1: Unexamined Japanese Patent Applications Laid-Open No. 07-319716

### SUMMARY OF THE INVENTION

### Problem to be Solved by the Invention

The technique conventionally employed has the following technical problem. A software program is often designed such that the exclusion control interval is as short as possible to better a throughput and effectively use a processor. Therefore, it is probably unlikely that any process which already acquired the lock object remains unexecuted (right of execution by the processor is assigned to any other process). The unlikelihood is more apparent particularly in software programs developed for any embedded devices in view of more accurately estimating the execution time of processes. Therefore, there is not much expectation for improvement of a system throughput when the conventional technique is employed because the busy waiting is mostly selected whenever an attempt to acquire the lock object fails.

The present invention was accomplished to solve the existing technical problem described so far, and a main object thereof is to provide an exclusion control method and an exclusion control system which succeed in improving a throughput.

### Means for Solving the Problem

1] An exclusion control method for a multiprocessor according to the present invention is an exclusion control method for a multiprocessor having a lock object corresponding to a system resource, comprising:

a first step in which whether locking of the lock object by a process succeeds is determined when the process attempts to lock the lock object; and

a second step in which the process is executed at a relatively high processing speed in an interval during which the locking is valid as compared to an interval during which the locking is invalid when the first step determines that the locking succeeded.

According to the exclusion control method wherein the process which succeeded in locking the lock object is executed at a relatively high processing speed, the locking valid interval can be shorter than in a normal speed operation. This technical advantage improves a system throughput.

2] An exclusion control method for a multiprocessor according to the present invention is an exclusion control method for a multiprocessor having a lock object corresponding to a system resource, comprising:

a first step in which whether a first locking of the lock object by a first process succeeds is determined when the first locking is attempted;

a second step in which a second process which already succeeded in locking the lock object is identified when the first step determines that the first locking failed; and

a third step in which the second process is executed at a relatively high processing speed in an interval during which a second locking of the lock object by the second process is valid as compared to an interval during which the second locking is invalid.

According to the exclusion control method, the second process which succeeded in locking the lock object is identified by the first process which failed to lock the lock object, and the second process is executed at a relatively high processing speed in the interval during which the second locking of the lock object by the second process is valid as compared to the second locking invalid interval. The first process busy waiting is not idling away time but plays such a productive role as making the second process be executed at a higher processing speed, so that the second process can be executed within a shorter period of time in the locking valid interval than in a normal speed operation. This technical advantage improves a system throughput.

3] An exclusion control method for a multiprocessor according to the present invention is an exclusion control method for a multiprocessor having a lock object corresponding to a system resource, comprising:

a first step in which whether a first locking of the lock object by a process succeeds is determined when the first locking is attempted; and

a second step in which the process prepares for a relatively high speed operation in an interval during which a successful second locking of the lock object attempted next by the process is valid as compared to an interval during which the second locking is invalid when the first step determines that the first locking failed.

According to the exclusion control method wherein the process prepares for a next success in locking the lock object, making it unnecessary to identify any other process which succeeded in locking the lock object. The process busy waiting is not idling away time but plays such a productive role as preparing for a relatively high speed operation, so that the process can be executed within a shorter period of time in the locking valid interval than in a normal speed operation. This technical advantage improves a system throughput.

4] The exclusion control method recited in 1] or 2] preferably further includes a third step in which the relatively high speed operation of the process is reverted to a normal speed operation as soon as the lock object is unlocked when the locking valid interval is over. The process is executed at a relatively high processing speed during the locking valid interval, but the process is executed at a normal processing speed again when the high speed operation is over to unlock the lock object.

5] The exclusion control method recited in 4] preferably further includes a fifth step in which gathering of an information in the locking valid interval is commenced when the first step determines that the locking succeeded, and the information gathering is quitted as soon as the lock object is unlocked when the locking valid interval is over. According to the exclusion control method, the information of the locking valid interval is analyzed in a manner suitable for the lock object so that the process can be executed at a relative high processing speed based on the analyzed information.

6] In the exclusion control method recited in 5], a time length of the locking valid interval is preferably measured and recorded in a fourth step. According to the exclusion control method wherein the measured and recorded execution time is used to analyze any tendency of the locking valid interval, the process can be executed at a relative high processing speed in a manner most stable for the interval.

7] In the exclusion control method recited in 5], a history of instructions carried out during the locking valid interval are preferably gathered and recorded in the fourth step. According to the exclusion control method wherein the gathered and recorded history of instructions are used to analyze any tendency of the locking valid interval, the process can be executed at a relative high processing speed during the interval in a manner most stable for the interval.

8] In the exclusion control method recited in 5], a history of addresses of data accessed during the locking valid interval are preferably gathered and recorded in the fourth step. According to the exclusion control method wherein the gathered and recorded history of addresses are used to analyze any tendency of the locking valid interval, the process can be executed at a relative high processing speed during the interval in a manner most stable for the interval.

9] In the exclusion control method recited in 1] or 2], an operation frequency of a device which runs the multiprocessor is preferably elevated to execute the process at the relatively high processing speed in the second step. When the operation frequency is thus elevated, the processing speed at which the process is executed can be directly increased.

10] In the exclusion control method recited in 1] or 2], instructions to be carried out by the process during the locking valid interval are preferably loaded on a cache memory to execute the process at the relatively high processing speed in the second step. When the cache memory is thus used to carry out the instructions, the processing speed can be increased. The cache memory is mounted in most of processors in a relatively simplified manner.

11] In the exclusion control method recited in 1] or 2], data to be accessed by the process during the locking valid interval is preferably loaded on a cache memory to execute the process at the relatively high processing speed in the second step. When the cache memory is thus used to access the data, the processing speed can be increased. The cache memory is mounted in most of processors in a relatively simplified manner.

12] In the exclusion control method recited in 1], instructions to be carried out by the process during the locking valid interval are preferably carried out by using a device capable of high speed operability to execute the process at the relatively high processing speed in the second step. The device capable of high speed operability enables the processing speed to be accelerated. The device capable of high speed operability is not an always-on device but is used during the locking valid interval alone. As a result, power consumption can be reduced.

13] In the exclusion control method recited in 1], data to be accessed by the process during the locking valid interval is preferably accessed by using a device capable of high speed operability to execute the process at the relatively high processing speed in the second step. The device capable of high speed operability enables the processing speed to be accelerated. The device capable of high speed operability is not an always-on device but is used during the locking valid interval alone. As a result, power consumption can be reduced.

14] In the exclusion control method recited in 1], instructions to be carried out by the process during the locking valid interval are preferably carried out in parallel by using a plurality of processors to execute the process at the relatively high processing speed in the second step. When the instructions are thus carried out in parallel by the plurality of processors, the processing speed can be accelerated.

15] In the exclusion control method recited in 3], instructions to be carried out by the process during the second locking valid interval are preferably loaded on a cache memory to execute the process at the relatively high processing speed in the second step. When the cache memory is thus used to carry out the instructions, the processing speed can be accelerated.

16] In the exclusion control method recited in 3], data to be accessed by the process during the locking valid interval is preferably loaded on a cache memory to execute the process at the relatively high processing speed in the second step. When the cache memory is thus used to access the data, the processing speed can be accelerated.

In the sections 1]-16], the exclusion control method for the multiprocessor was described. Hereinafter, an exclusion control system for a multiprocessor according to the present invention is described.

17] An exclusion control system for a multiprocessor according to the present invention is an exclusion control system for a multiprocessor having a lock object corresponding to a system resource, comprising:

a determination device configured to determine whether locking of the lock object by a process succeeds when the process attempts to lock the lock object; and

a relatively high speed operation processing device configured to execute the process at a relatively high processing speed in an interval during which the locking is valid as compared to an interval during which the locking is invalid when the determination device determines that the locking succeeded.

According to the exclusion control system wherein the process which succeeded in locking the lock object is executed at a relatively high processing speed, the locking valid interval can be shorter than in a normal speed operation. This technical advantage improves a system throughput.

18] An exclusion control system for a multiprocessor according to the present invention is an exclusion control system for a multiprocessor having a lock object corresponding to a system resource, comprising:

a determination device configured to determine whether a first locking of the lock object by a first process succeeds when the first process attempts to lock the lock object;

an identifying device configured to identify a second process which already succeeded in locking the lock object when the determination device determines that the first locking failed; and

a relatively high speed operation processing device configured to execute the second process at a relatively high processing speed in an interval during which a second locking of the lock object by the second process is valid as compared to an interval during which the second locking is invalid.

The exclusion control system thus configured is equivalent to the exclusion control method recited in 2].

According to the exclusion control system, the second process which succeeded in locking the lock object is identified by the first process which failed to lock the lock object, and the second process is executed at a processing speed higher in the interval during which the second locking of the lock object by the second process is valid as compared to the second locking invalid interval. According to the exclusion control system, the first process busy waiting is not idling away time but plays such a productive role as making the second process be executed at a higher processing speed, so that the second process can be executed within a shorter period of time in the locking valid interval than in a normal speed operation. This technical advantage improves a system throughput.

19] An exclusion control system for a multiprocessor according to the present invention is an exclusion control system for a multiprocessor having a lock object corresponding to a system resource, comprising:

a determination device configured to determine whether a first locking of the lock object by a process succeeds when the first locking is attempted; and

a relatively high speed operation processing device configured to make the process execute in a relatively high speed operation in an interval during which a successful second locking of the lock object attempted next by the process is valid as compared to an interval during which the second locking is invalid when the determination device determines that the first locking failed.

The exclusion control system thus configured is equivalent to the exclusion control method recited in 3].

According to the exclusion control system wherein the process prepares for a next success in locking the lock object, making it unnecessary to identify any other process which succeeded in the locking the lock object. The process busy waiting is not idling away time but plays such a productive role as preparing for a relatively high speed operation, so that the process can be executed within a shorter period of time in the locking valid interval than in a normal speed operation. This technical advantage improves a system throughput

20] The exclusion control system recited in 17] or 18] preferably further includes a reverting device configured to revert the relatively high speed operation of the process to a normal speed operation as soon as the lock object is unlocked when the locking valid interval is over. The process is executed at a relatively high processing speed during the locking valid interval, but the process is executed at a normal processing speed again when the high speed processing interval is over to unlock the lock object. The exclusion control system thus configured is equivalent to the exclusion control method recited in 4].

21] The exclusion control system recited in 20] preferably further includes a gathering device configured to commence gathering of an information in the locking valid interval when the determination device determines that the locking succeeded and quit the information gathering as soon as the lock object is unlocked when the locking valid interval is over. The exclusion control system thus configured is equivalent to the exclusion control method recited in 5]. According to the exclusion control system, the information of the locking valid interval is analyzed in a manner suitable for the lock object so that the process can be executed at a relative high processing speed based on the analyzed information.

22] In the exclusion control system recited in 21], the gathering device preferably measures and records a time length of the locking valid interval. The exclusion control system thus configured is equivalent to the exclusion control method recited in 6]. According to the exclusion control system wherein the measured and recorded execution time is used to analyze any tendency of the locking valid interval, the process can be executed at a relative high processing speed during the interval in a manner most stable for the interval.

23] In the exclusion control system recited in 21], the gathering device preferably gathers and records a history of instructions carried out during the locking valid interval. The exclusion control system thus configured is equivalent to the exclusion control method recited in 7]. According to the exclusion control system wherein the gathered and recorded history of instructions are used to analyze any tendency of the locking valid interval, the process can be executed at a relative high processing speed during the interval in a manner most stable for the interval.

24] In the exclusion control system recited in 21], the gathering device preferably gathers and records a history of addresses of data accessed during the locking valid interval. The exclusion control system thus configured is equivalent to the exclusion control method recited in 8]. According to the exclusion control system wherein the gathered and recorded history of addresses are used to analyze any tendency of the locking valid interval, the process can be executed at a relative high processing speed during the interval in a manner most stable for the interval.

25] In the exclusion control system recited in 17] or 18], the relatively high speed operation processing device preferably elevates an operation frequency of a device which runs the multiprocessor to execute the process at the relatively high processing speed. The exclusion control system thus configured is equivalent to the exclusion control method recited in 9]. When the operation frequency is thus elevated, the processing speed at which the process is executed can be directly increased.

26] In the exclusion control system recited in 17] or 18], the relatively high speed operation processing device preferably loads instructions to be carried out by the process during the locking valid interval on a cache memory to execute the process at the relatively high processing speed. The exclusion control system thus configured is equivalent to the exclusion control method recited in 10]. When the cache memory is thus used to carry out the instructions, the processing speed can be accelerated. The cache memory is mounted in most of processors in a relatively simplified manner.

27] In the exclusion control system recited in 17] or 18], the relatively high speed operation processing device preferably loads data to be accessed by the process during the locking valid interval on a cache memory to execute the process at the relatively high processing speed. The exclusion control system thus configured is equivalent to the exclusion control method recited in 11]. When the cache memory is thus used to access the data, the processing speed can be accelerated. The cache memory is mounted in most of processors in a relatively simplified manner.

28] In the exclusion control system recited in 17], the relatively high speed operation processing device preferably uses a device capable of high speed operability to carry out instructions to be carried out by the process during the locking valid interval so that the process is executed at the relatively high processing speed. The exclusion control system thus configured is equivalent to the exclusion control method recited in 12]. The device capable of high speed operability enables the processing speed to be accelerated. The device capable of high speed operability is not an always-on device but is used during the locking valid interval alone. As a result, power consumption can be reduced.

29] In the exclusion control system recited in 17], the relatively high speed operation processing device preferably uses a device capable of high speed operability to access data to be accessed by the process during the locking valid interval so that the process is executed at the relatively high processing speed. The exclusion control system thus configured is equivalent to the exclusion control method recited in 13]. The device capable of high speed operability enables the processing speed to be accelerated. The device capable of high speed operability is not an always-on device but is used during the locking valid interval alone. As a result, power consumption can be reduced.

30] In the exclusion control system recited in 17], the relatively high speed operation processing device preferably uses a plurality of processors to carry out in parallel instructions to be carried out by the process during the locking valid interval so that the process is executed at the relatively high processing speed. The exclusion control system thus configured is equivalent to the exclusion control method recited in 14]. When the instructions are thus carried out in parallel by the plurality of processors, the processing speed can be accelerated.

31] In the exclusion control system recited in 19], the relatively high speed operation processing device preferably loads instructions to be carried out by the process on a cache memory during the second locking valid interval so that the process is executed at the relatively high processing speed. The exclusion control system thus configured is equivalent to the exclusion control method recited in 15]. When the cache memory is thus used to carry out the instructions, the processing speed can be accelerated.

32] In the exclusion control system recited in 19], the relatively high speed operation processing device preferably loads data to be accessed by the process during the locking valid interval on a cache memory so that the process is executed at the relatively high processing speed. The exclusion control system thus configured is equivalent to the exclusion control method recited in 16]. When the cache memory is thus used to access the data, the processing speed can be accelerated.

In the sections 17]-32], the exclusion control system for the multiprocessor was described. A hard disc recorder according to the present invention is described below.

33] A hard disc recorder according to the present invention comprises:

a data retention device configured to retain a content therein;

a content transfer device configured to transfer the content to an apparatus capable of communicating with the content transfer device;

an exclusion control device configured to control the content transfer device so that the content transfer device currently transferring the content is not used by any apparatus but the apparatus receiving the transferred content; and

a relatively high speed operation processing device configured to transmit an instruction to make the apparatus receiving the transferred content operate at a relatively high processing speed as compared to an interval during which the content is not transferred.

The hard disc recorder makes the apparatus exclusively using the content transfer device operate at a relatively high processing speed so that the content transfer device is operational within a shorter period of time than in a normal speed operation. This technical advantage lessens a waiting time of any apparatus waiting to exclusively use the content transfer device.

A mobile terminal according to the present invention is described below.

34] A mobile terminal according to the present invention comprises:

an external apparatus utilization device configured to perform data communication with a function device of an external apparatus exclusively utilizable; and

a relatively high speed operation processing device configured to make the external apparatus utilization device operate at a relatively high processing speed in an interval during which the external apparatus utilization device is performing the data communication with the function device as compared to an interval during which the external apparatus utilization device is not performing the data communication with the function device.

The mobile terminal thus configured is equivalent to 1] and 17].

35] A mobile terminal according to the present invention comprises:

an external apparatus utilization device configured to perform data communication with a function device of an external apparatus exclusively utilizable;

an identifying device configured to identify another mobile terminal based on a data content obtained by the data communication when the function device is no longer available because the function device is already performing the data communication with the another mobile terminal; and

a relatively high speed operation processing device configured to transmit an instruction to make the another mobile terminal operate at a relatively high processing speed in an interval during which the another terminal is performing the data communication with the function device as compared to an interval during which the another terminal is not performing the data communication with the function device.

The mobile terminal thus configured is equivalent to 2] and 18].

36] A mobile terminal according to the present invention comprises:

an external apparatus utilization device configured to perform data communication with a function device of an external apparatus exclusively utilizable; and

a relatively high speed operation processing device configured to make the external apparatus utilization device prepare for a relatively high speed operation in an interval during which the external apparatus utilization device is performing the data communication with the function device as compared to an interval during which the external apparatus utilization device is not performing the data communication with the function device when the data communication currently unavailable between the external apparatus utilization device and the function device is made available therebetween.

The mobile terminal thus configured is equivalent to 3] and 19].

### Effect of the Invention

The exclusion control method according to the present invention improves a throughput in a system wherein it is necessary to wait for a lock object to be released while busy waiting when an attempt to acquire the lock object fails.

### BRIEF DESCRIPTION OF THE DRAWINGS

FIG. 1 is a block diagram illustrating a system configuration wherein exclusion control methods according to exemplary embodiments 1, 2 and 3 of the present invention are employed.

FIG. 2 is a flow chart illustrating processing steps for acquiring a lock object (locking) in the exclusion control method according to exemplary embodiment 1.

FIG. 3 is a flow chart illustrating processing steps for releasing the lock object (unlocking) in the exclusion control method according to exemplary embodiment 1.

FIG. 4 is a flow chart illustrating processing steps for commencing gathering of information of a locking interval in the exclusion control methods according to the exemplary embodiments 1, 2 and 3.

FIG. 5 is a flow chart illustrating processing steps for quitting gathering of information of a locking interval in the exclusion control methods according to the exemplary embodiments 1, 2 and 3.

FIG. 6 is a flow chart illustrating processing steps for acquiring the lock object (locking) in the exclusion control method according to exemplary embodiment 2.

FIG. 7 is a flow chart illustrating processing steps for acquiring the lock object (locking) in the exclusion control method according to exemplary embodiment 3.

FIG. 8 is a block diagram illustrating a group apparatuses according to exemplary embodiments 4, 5, and 6 of the present invention.

FIG. 9 is a flow chart illustrating lock acquiring (locking) processing steps by a content transfer device 71 in the group of apparatuses according to the exemplary embodiment 4.

FIG. 10 is a flow chart illustrating lock releasing (unlocking) processing steps by the content transfer device 71 in the apparatuses according to the exemplary embodiment 4.

FIG. 11 is a flow chart illustrating lock acquiring (locking) processing steps by a content transfer device 71 in the apparatuses according to the exemplary embodiment 5.

FIG. 12 is a flow chart illustrating lock acquiring (locking) processing steps by a content transfer device 71 in the apparatuses according to the exemplary embodiment 6.

FIG. 13 is a flow chart illustrating conventional processing steps for acquiring a lock object (locking).

FIG. 14 is a flow chart illustrating conventional processing steps for releasing a lock object (unlocking).

### EXEMPLARY EMBODIMENTS FOR CARRYING OUT THE INVENTION

### Exemplary Embodiment 1

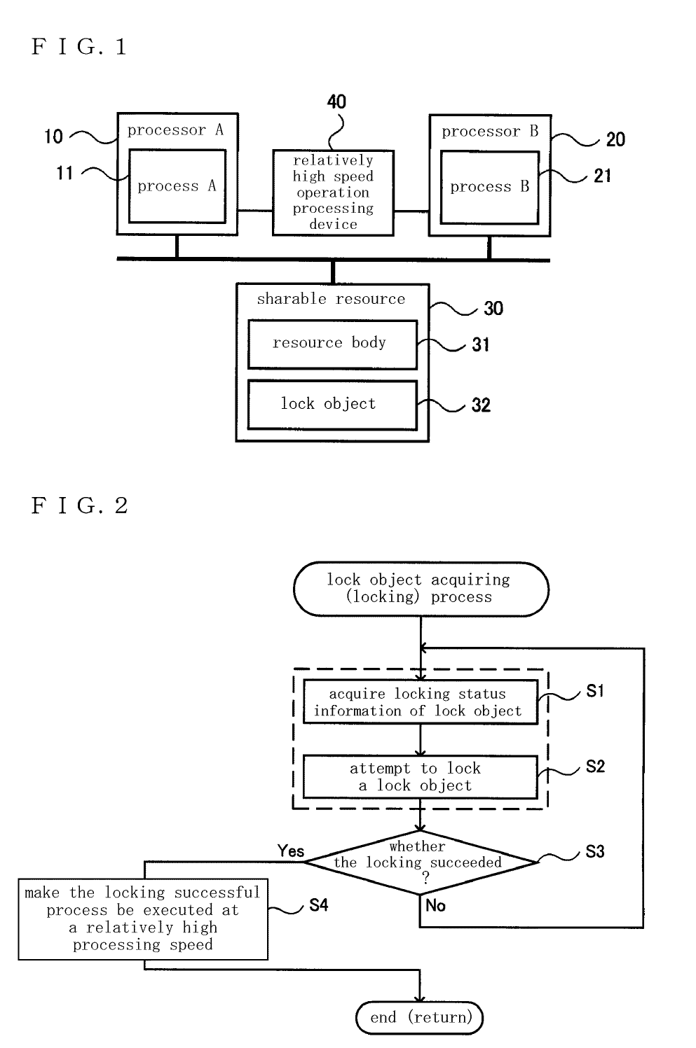

FIG. 1 illustrates a system configuration wherein an exclusion control method according to an exemplary embodiment 1 of the present invention is employed. The system has a processor A10, a processor B20, a sharable resource 30, and a relatively high speed operation processing device 40. In the description given below, a process A11 is currently in execution in the processor A10, and a process B21 is currently in execution in the processor B20.

The sharable resource 30 has a resource body 31 and a lock object 32. Because the resource 30 is shared by a plurality of processes, exclusion control is necessary to use the resource 30. The lock object 32 manages locking information indicating whether the sharable resource is locked (already acquired by any process) or unlocked (not yet acquired by any process). The locking information of the lock object 32 is acquired and updated in a sequence of processing steps to be inseparably executed (atomic operation).

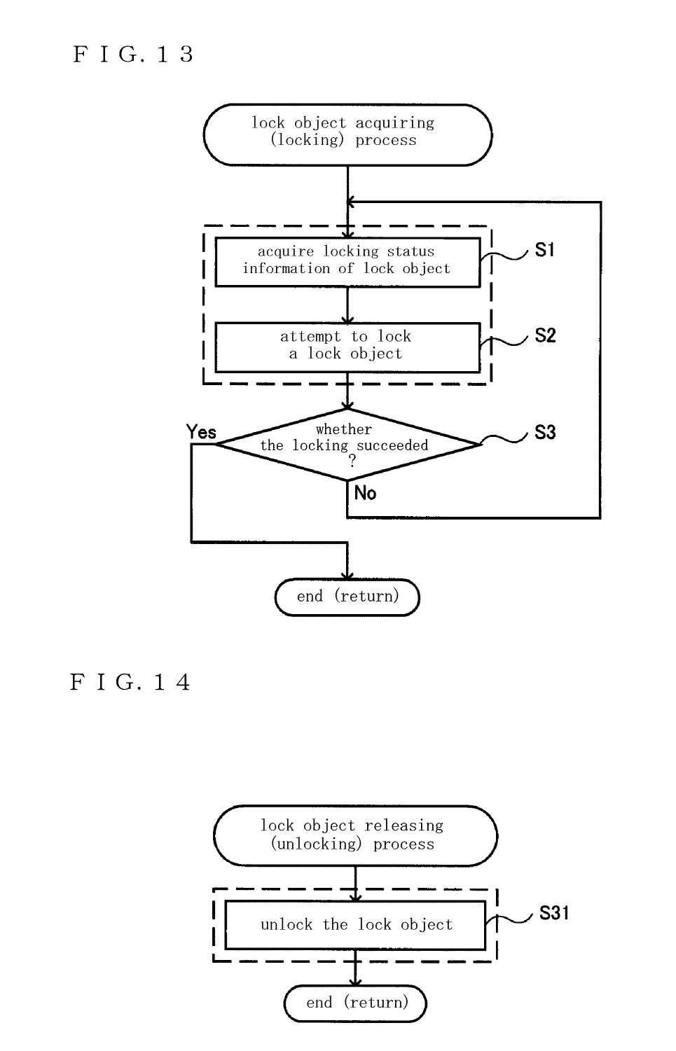

The relatively high speed operation processing device 40, for example, controls operation frequencies of the processor A10 and the processor B20. FIG. 2 is a flow chart illustrating processing steps for acquiring a lock object (locking) in the exclusion control method according to exemplary embodiment 1. The exclusion control method according to exemplary embodiment 1 is different to the conventional method illustrated in FIG. 13 in that Step S4 is added. The present exemplary embodiment is technically characterized in that when one of the processes successfully locked the lock object, the successful process is executed at a relatively high processing speed in a locking interval. In the present exemplary embodiment, Step S3 is equivalent to a determination device, and Step S4 is equivalent to a relatively high speed operation processing device.

When the process A11 wants to use the sharable resource 30 before the process B21, in Step S1, the process A11 obtains the current locking information of the lock object 32. In Step S2, the process A11 attempts to lock the lock object 32. In Step S3, whether the locking succeeded is determined. With the locking information obtained in Step S1 indicating that the lock object 32 is still unlocked, it is determined in Step S3 that the process A11 succeeded in locking the lock object 32. Then, the process A11 proceeds to Step S4. In Step S4, the process A11 controls the relatively high speed operation processing device 40 so that the processor A10 executes the process A11 at a relatively high processing speed as compared to a locking invalid interval. Then, the process A11 ends the lock object acquiring process.

When the process B21 wants to use the sharable resource 30 after the process B21, in Step S1, the process B21 obtains the current locking information of the lock object 32. In Step S2, the process B21 attempts to lock the lock object 32. However, the locking information already updated by the process A11 to indicate the locking condition remains unchanged. In Step S3, whether the locking succeeded is determined. With the locking information obtained in Step S1 indicating the locking condition, it is determined in Step S3 that the process B21 failed to lock the lock object, and the process B21 returns to Step S1. In the exclusion control described so far, Step S1 and Step S2 are a sequence of processing steps to be inseparably executed.

In Step S4, the relatively high speed operation processor 4 elevates the operational frequency of any device currently operating so as to commensurate with a time length or number of instructions previously fixed to a given value. When the operation frequency is thus elevated so as to commensurate with the time length or number of instructions previously fixed, a whole system throughput can be improved in a relatively simplified manner.

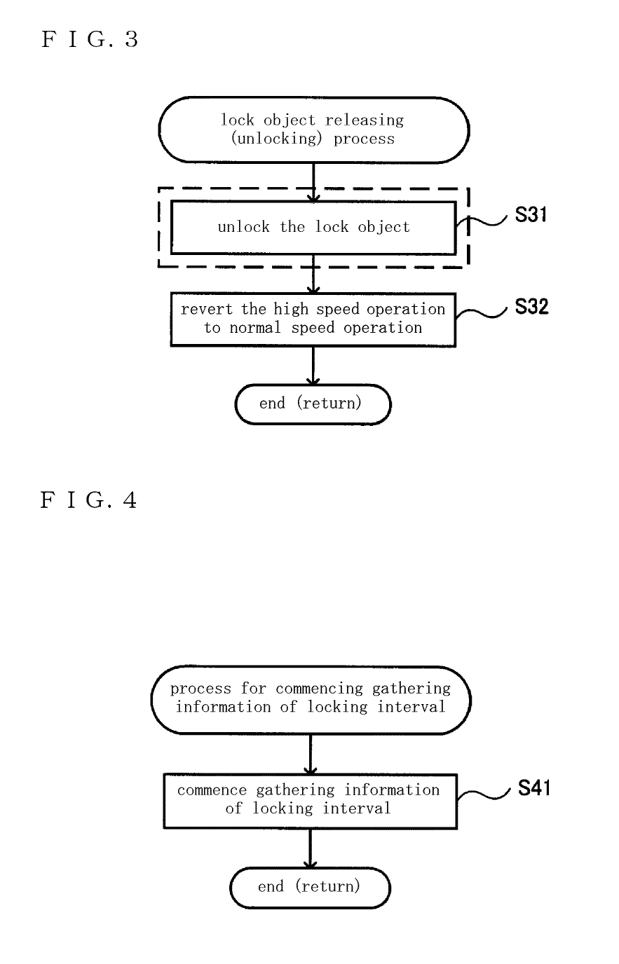

FIG. 3 is a flow chart illustrating processing steps for releasing the lock object (unlocking) in the exclusion control method according to exemplary embodiment 1. As compared to the conventional processing steps illustrated in FIG. 14, the processing steps further include S32. In the present exemplary embodiment, Step S32 is equivalent to a reverting device.

In Step s31, the lock object 32 is unlocked. In Step S32, the high speed operation is reverted to a normal speed operation. Then, the lock object releasing process ends. S31 is a part of a sequence of processing steps alongside Steps S1 and S2 to be inseparably executed.

When the lock object releasing (unlocking) process is employed, Step S4 illustrated in FIG. 2 can revert the high speed operation to a normal speed operation, meaning reverting the operation frequency to an original operation frequency, by releasing the lock object (unlocking) in Step S32 illustrated in FIG. 3, making it unnecessary to preset the time length or number of instructions. The relatively high speed operation continues until the process releases the lock object.

In Step S4, instructions to be carried out and data to be accessed during the locking interval may be loaded on an instruction cache memory and a data cache memory. The cache memories are mounted in most of processors in a relatively simplified manner. In Step S4, instructions to be carried out and data to be accessed during the locking interval may be transferred to a device capable of high speed operability to be carried out and accessed in the device. The device capable of high speed operability enables the processing speed be accelerated. The device capable of high speed operability not an always-on device but is used during the locking interval alone. As a result, power consumption can be reduced.

FIG. 4 is a flow chart illustrating processing steps for commencing gathering of information of the locking interval. In Step S41, the information gathering of the locking interval is commenced. Examples of the information are a length of time of the locking interval, number of instructions during the locking interval, and addresses of data to be accessed during the locking interval. Step S41 commences gathering of such information by:
activating a timer tailored the lock object 32;
activating a device tailored for the lock object 32 to acquire a history of instructions carried out; or
activating a device tailored for the lock object 32 to acquire a history of addresses of accessed data.

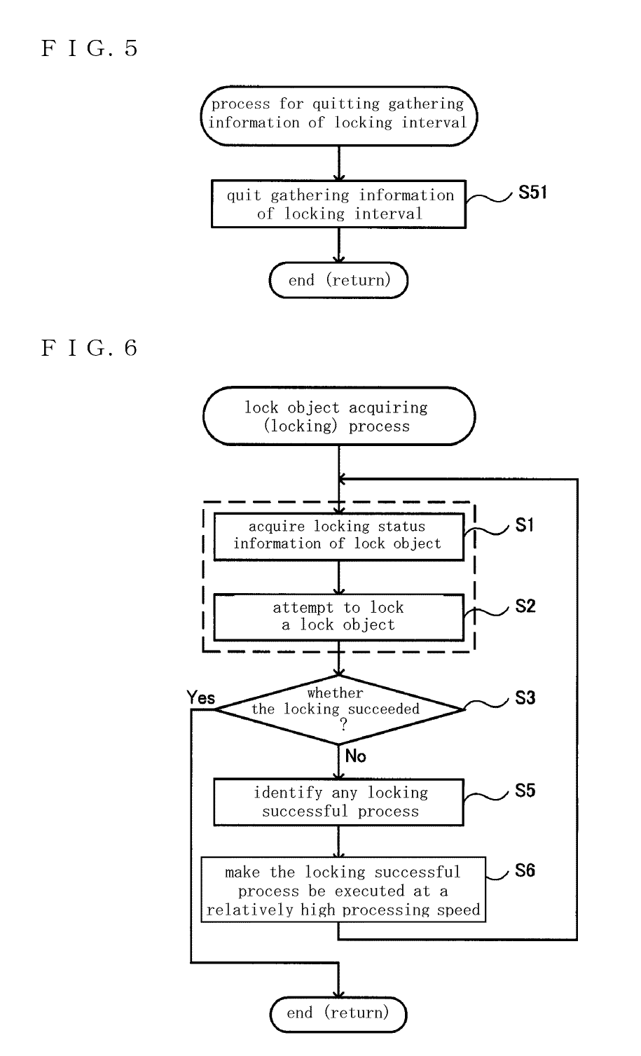

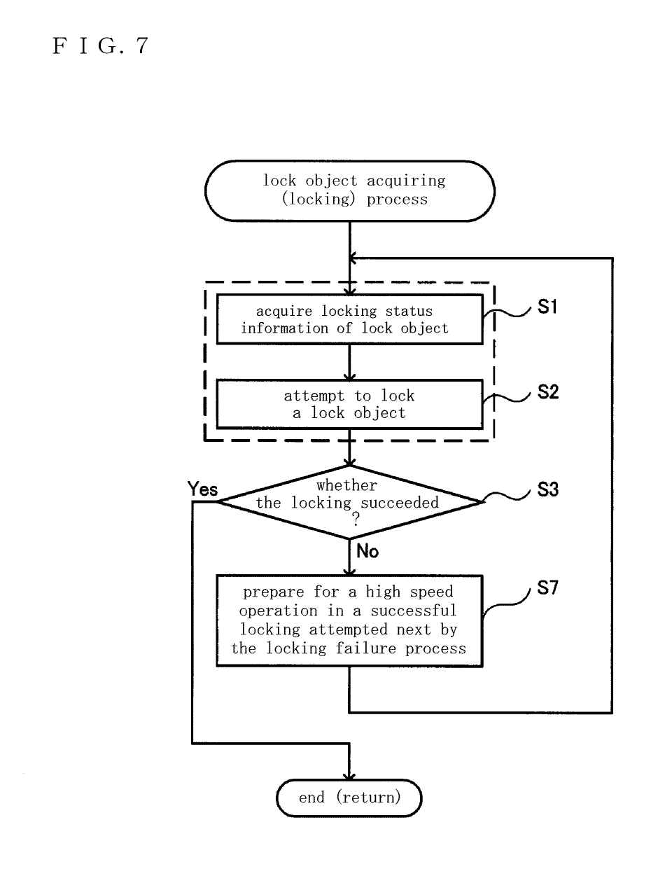

FIG. 5 is a flow chart illustrating processing steps for quitting the information gathering of the locking interval. In Step S51, the information gathering of the locking interval is quitted. To continue the information gathering which started in Step S41 through to Step S51, Step S51 quits the information gathering after:
halting the timer tailored for the lock object 32 to store the length of time of the locking interval;
halting the device tailored for the lock object 32 to acquire a history of instructions to store the instructions carried out during the locking interval; or
halting the device tailored for the lock object 32 to acquire a history of addresses of accessed data to store the addresses of the data accessed during the locking interval.

In the present exemplary embodiment, Steps S41 and S51 are equivalent to a gathering device.

When the information gathering of the locking interval is commenced as illustrated in FIG. 4 immediately before Step S4 and the information gathering is quitted as illustrated in FIG. 5 in or after S31, Step S4 may analyze the information of the locking interval to select a method of accelerating the processing speed to a relatively high processing speed based on the analyzed information. Determining that the locking interval is longer than a given threshold value, the device operation frequency is elevated. Determining that the instructions to be executed during the locking interval are easily loaded on the cache line, the instructions are loaded on the cache line in advance. Determining that the addresses of the data to be accessed during the locking interval are easily loaded on the cache line, the addresses are loaded on the cache line in advance.

The present invention is not necessarily limited to the present exemplary embodiment. The present invention is applicable to a hardware device or an integrated circuit equipped with these processing devices, a method including processing steps, or a program configured to run the processing steps on a computer. The program may be distributed through a recording medium such as CD-ROM or a communication medium such as the Internet.

According to the present exemplary embodiment thus technically advantageous, the process which succeeded in locking the lock object is executed at a relatively high processing speed. Thus, the process can be executed within a shorter period of time in the locking valid interval than in a normal speed operation.

### Exemplary Embodiment 2

A system wherein an exclusion control method according to an exemplary embodiment 2 of the present invention is employed is configured similarly to the illustration of FIG. 1 according to the exemplary embodiment 1, therefore, description of the system is omitted. FIG. 6 is a flow chart illustrating processing steps for acquiring the lock object (locking) in the exclusion control method according to exemplary embodiment 2. The processing steps further include Steps S5 and S6 as compared to the conventional processing steps illustrated in FIG. 13. The present exemplary embodiment is technically characterized in that when a process (first process) failed to lock the lock object, a different process which succeeded in locking the lock object (second process) is identified so that the identified process which succeeded in the locking is executed at a relatively high processing speed in the locking interval as compared to the locking invalid interval. In the present exemplary embodiment, Step S3 is equivalent to a determination device, Step S5 is equivalent to an identifying device, and Step S6 is equivalent to a relatively high speed operation processing device.

When the process A11 wants to use the sharable resource 30 before the process B21, in Step S1, the process A11 obtains the current locking information of the lock object 32. In Step S2, the process A11 attempts to lock the lock object 32. In Step S3, whether the locking succeeded is determined. With the locking information obtained in Step S1 indicating that the lock object 32 is still unlocked, it is determined in Step S3 that the process A11 succeeded in locking the lock object 32. Then, the process A11 ends the lock object acquiring process.

When the process B21 wants to use the sharable resource 30 after the process A11, in Step S1, the process B21 obtains the current locking information of the lock object 32. In Step S2, the process B21 attempts to lock the lock object 32. However, the locking information already updated by the process A11 to indicate the locking condition remains unchanged. In Step S3, whether the locking succeeded is determined. With the locking information obtained in Step S1 indicating the locking condition, it is determined in Step S3 that the process B11 failed to lock the lock object 32. Then, the process B21 proceeds to Step S5. In Step S5, the process B21 identifies any process which succeeded in locking the lock object. In the example described here, the process A11 is identified as a locking successful process. When the process A11 is thus identified, information such as a program counter in execution and addresses accessed by the process A11 can be obtained. In Step S6, the process B21 controls the relatively high speed operation processing device 40 to make the process identified in Step S5 be executed at a relatively high processing speed as compared to the locking invalid interval. Then, the process B21 returns to Step S1.

In the processing steps, Step S1 and Step S2 are a sequence of processing steps to be inseparably executed. In Step S6, the relatively high speed operation processing device 40 elevates the operation frequency of any device currently operating in the process identified in Step S5 so that the process is executed at a relatively high processing speed. The processing speed can be accelerated so as to commensurate with a time length or number of instructions previously fixed to a given value.

To relatively increase the processing speed, the instructions to be executed and data to be accessed during the locking interval may be loaded on an instruction cache memory and a data cache memory. More specifically, the instructions and data may be loaded on the instruction cache memory and the data cache memory so as to commensurate with number of cache lines previously fixed to a given value.

In the case of two processors, Step S5 can identify the process currently in execution by the other processor as a locking successful process. When the lock object is successfully locked, information indicating which of the processes locked the process may be appended to the lock object, so that the appended information is read in Step S5 to identify the locking successful process. Another option for identifying the locking successful process is to provide a hardware device configured to automatically append information indicating which of the processes succeeded in locking the lock object. When Step S3 determined that the locking succeeded, information of the locking interval suitable for the lock object may be obtained by:
ending the lock object acquiring process after the processing step for commencing the information gathering of the locking interval illustrated in FIG. 4; and
quitting the information gathering of the locking interval illustrated in FIG. 5 immediately before Step S32 in the processing steps for releasing the lock object (unlocking) illustrated in FIG. 3 when the locking successful process releases the lock object,

so that Step S6 analyzes the information of the locking interval dependent upon the lock object to execute the process at a relatively high processing speed based on the analyzed information.

The present invention is not necessarily limited to the present exemplary embodiment. The present invention is applicable to a hardware device or an integrated circuit equipped with these processing devices, a method including processing steps, or a program configured to run the processing steps on a computer. The program may be distributed through a recording medium such as CD-ROM or a communication medium such as the Internet.

According to the present exemplary embodiment thus technically advantageous, a process which failed to lock the lock object identifies a different process which succeeded in locking the lock object and makes the successful process be executed at a relatively high processing speed during the locking interval. Therefore, the process which failed to lock the lock object busy waiting is not idling away time but plays such a productive role as making the locking successful process be executed at a relatively high processing speed. As a result, the process can be executed within a shorter period of time in the locking valid interval than in a normal speed operation.

### Exemplary Embodiment 3

A system wherein an exclusion control method according to an exemplary embodiment 3 of the present invention is employed is configured similarly to the illustration of FIG. 1 according to the exemplary embodiment 1, therefore, description of the system is omitted. A relative speed operation processing device 40 according to the present exemplary embodiment, however, is configured to load instructions and data on cache memories of the processor A10 and the processor B20.

FIG. 7 is a flow chart illustrating processing steps for acquiring the lock object (locking) in the exclusion control method according to exemplary embodiment 3. The processing steps are different to the conventional processing step illustrated in FIG. 13 in that Step S7 is further included. The present exemplary embodiment is technically characterized in that when a process failed to lock the lock object but later succeeded in a next attempt, the process is executed at a relatively high processing speed in the locking interval as compared to the locking invalid interval.

When the process A11 wants to use the sharable resource 30 before the process B21, in Step S1, the process A11 obtains the current locking information of the lock object 32. In Step S2, the process A11 attempts to lock the lock object 32. In Step S3, whether the locking succeeded is determined. With the locking information obtained in Step S1 indicating that the lock object 32 is still unlocked, it is determined that the process A11 succeeded in locking the lock object. Then, the process A11 ends the lock object acquiring process.

When the process B21 wants to use the sharable resource 30 after the process B21, in Step S1, the process B21 obtains the current locking information of the lock object 32. In Step S2, the process B21 attempts to lock the lock object 32. However, the locking information already updated by the process A11 to indicate that the lock object is locked remains unchanged. In Step S3, whether the locking succeeded is determined. With the locking information obtained in Step S1 indicating that the lock object is already locked, it is determined in Step S3 that the process B21 failed to lock the lock object. Then, the process B21 proceeds to Step S7. In Step S7, the process B21 controls the relatively high speed operation processing device 40 so that the process B21 which once failed to lock the lock object 32 but succeeded in locking the lock object 32 in a next attempt is executed at a relatively high processing speed as compared to the locking invalid interval. Then, the process B21 returns to Step S1.

Step S1 and Step S2 are a sequence of processing steps to be inseparably executed. Step S7 loads instructions to be executed and data to be accessed during the locking interval on an instruction cache memory and a data cache memory to use the information loaded on the cache memories after a next successful locking attempt to lock the lock object. As a result, the locking failure process B21 can be executed at a relatively high processing speed as compared to the locking invalid interval. The instructions and data may be loaded on the cache memories so as to commensurate with number of cache lines previously fixed to a given value.

When Step S3 determined that the locking succeeded, information of the locking interval dependent upon the lock object may be obtained by:
ending the lock object acquiring process after the processing step for commencing gathering of the information of the locking interval illustrated in FIG. 4; and
quitting the information gathering of the locking interval illustrated in FIG. 5 immediately before Step S32 in the processing steps for releasing the lock object (unlocking) illustrated in FIG. 3 when the locking successful process releases the lock object,

so that Step S7 analyzes the information of the locking interval dependent upon the lock object to execute the process at a relatively high processing speed based on the analyzed information.

The present invention is not necessarily limited to the present exemplary embodiment. The present invention is applicable to a hardware device or an integrated circuit equipped with these processing devices, a method including processing steps, or a program configured to run the processing steps on a computer. The program may be distributed through a recording medium such as CD-ROM or a communication medium such as the Internet.

According to the present exemplary embodiment thus technically advantageous wherein the process which failed the locking prepares itself for a locking success in a next attempt, making it unnecessary to identify the locking successful process. Therefore, the process which failed to lock the lock object busy waiting is not idling away time but plays such a productive role as preparing itself for a higher speed operation. Thus, when the process which once failed to lock the lock object succeeds in locking the lock object in a next attempt, the process is executed at a relatively high processing speed. As a result, the process can be executed within a shorter period of time in the locking valid interval than in a normal speed operation.

### Exemplary Embodiment 4

Below is given a consideration to a situation where data content such as a television program data recorded and retained in a hard disc recorder in an individual house is downloaded in a mobile terminal away from the house to be viewed and/or listened. A family usually includes a plurality of family members and each of them may have his/her own mobile terminal. In that case, a mobile terminal A and a mobile terminal B possibly want to down load the content from the hard disc recorder at the same time. In the case where the hard disc recorder can only transfer the content to one mobile terminal at a time, the mobile terminal which requested later than the other has to wait for completion of the content transfer in the mobile terminal which requested the content earlier.

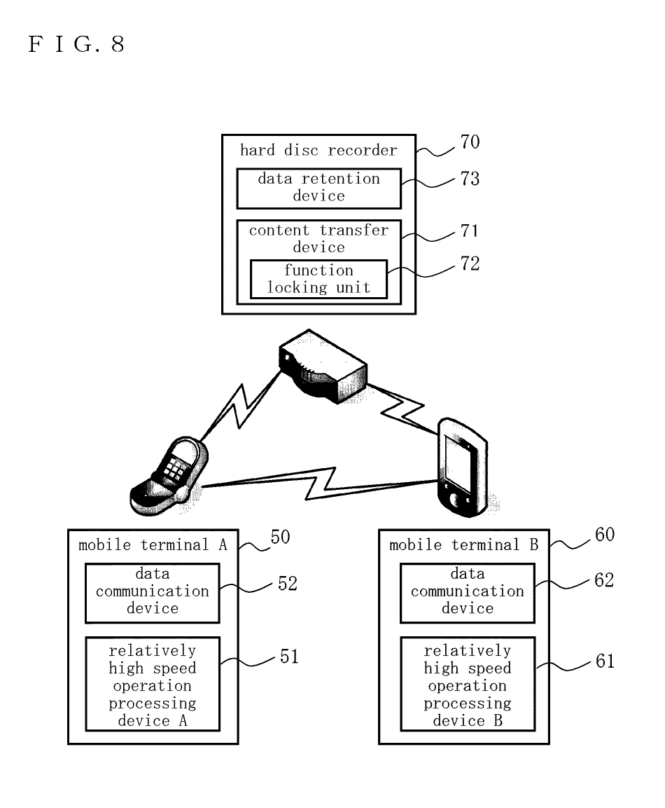

FIG. 8 illustrates a group of apparatuses according to an exemplary embodiment 4 of the present invention. The group of apparatuses illustrated in FIG. 8 includes a mobile terminal A50, a mobile terminal B60, and a hard disc recorder 70. The mobile terminal A50 and the mobile terminal B60 are examples of an apparatus capable of data communication. They are terminal apparatuses such as mobile telephone, PHS (Personal Handy System), or PDA (Personal Digital Assistant; mobile information terminal). The mobile terminal A50 and the mobile terminal B60 respectively have data communication devices 52 and 62 and relatively high speed operation processing devices A51 and B61. The data communication devices 52 and 62 are equivalent to an external apparatus utilization device.

The hard disc recorder 70 has a data retention device 73 configured to retain a content therein, and a content transfer device 71 capable of transferring the content retained in the data retention device 73 to a mobile terminal. The content transfer device 71 has a function locking unit 72 configured to make the content transfer device 71 exclusively available when a plurality of mobile terminals request to use the content transfer device 71. The function locking unit 72 manages locking information indicating whether the content transfer device 7 is locked (a mobile terminal is exclusively using the content transfer device 7) or unlocked (a mobile terminal is unable to exclusively use the content transfer device 7). The locking information managed by the function locking unit 72 is acquired and updated as a sequence of processing steps to be inseparably executed. The function locking unit 72 according to the present exemplary embodiment is equivalent to a relatively high speed operation processing device and an exclusion control device.

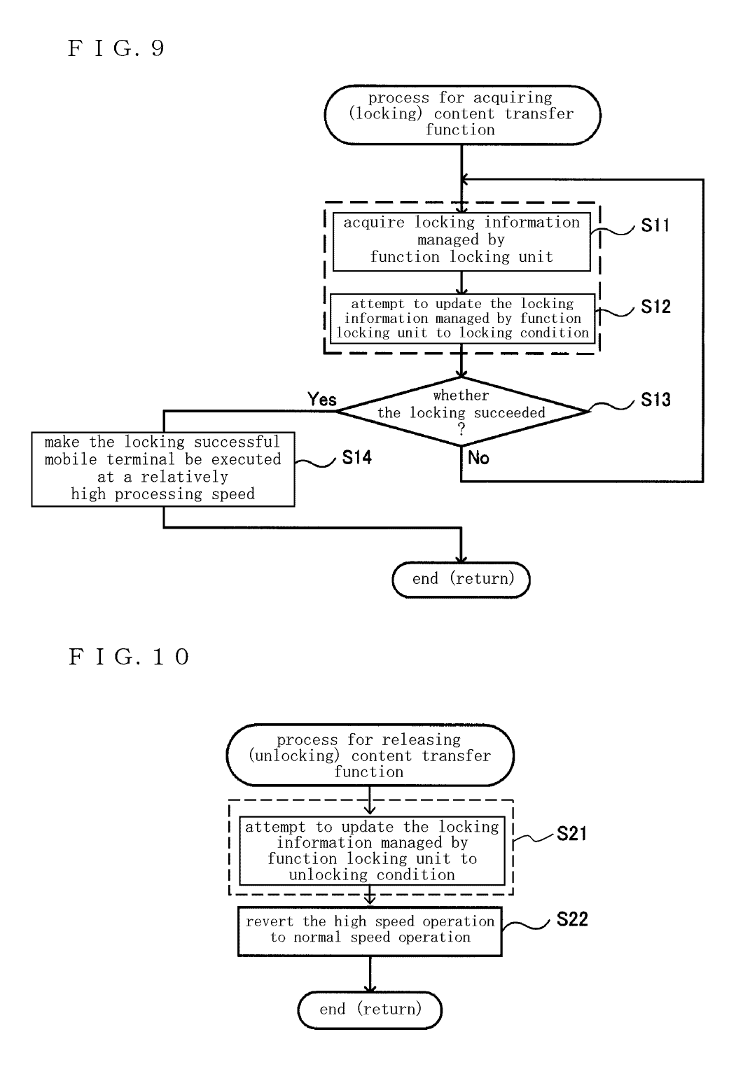

FIG. 9 is a flow chart illustrating lock acquiring (locking) processing steps by the content transfer device 71 in the apparatuses according to the exemplary embodiment 4. The present exemplary embodiment is technically characterized in that when the mobile terminals 50 and 60 are transferring the content using the content transfer device 71, the mobile terminals 50 and 60 execute their processes at a relatively high processing speed in an interval during which the content transfer device 71 is functioning (transfer interval) as compared to an interval during which the content transfer device 71 is not functioning.

When the mobile terminal A50 wants to use the content transfer device 71 before the mobile terminal B60, in Step S11, the mobile terminal A50 obtains the current locking information managed by the function locking unit 72.

In Step S12, the mobile terminal A50 updates the locking information managed by the function locking unit 72 to indicate the locking condition. With the locking information obtained in Step S11 indicating the unlocking condition, it is determined in Step S13 that the mobile terminal A50 succeeded in the locking, and then proceeds to Step S14. In Step S14, the mobile terminal A50 controls its own relatively high speed operation processing device A51 to make the mobile terminal A50 itself be executed at a relatively high processing speed, and then ends the lock acquiring process.

When the mobile terminal B60 wants to use the content transfer device 71 after the mobile terminal A50, in Step S11, the mobile terminal B60 obtains the current locking information managed by the function locking unit 72. In Step S12, the mobile terminal B60 attempts to update the locking information managed by the function locking unit 72 to indicate the locking condition. However, the locking information already updated by the mobile terminal A50 to indicate the locking condition remains unchanged. With the locking information obtained in Step S11 indicating the locking condition, it is determined in Step S13 that the mobile terminal B60 failed the locking, and the mobile terminal B60 returns to Step S11.

Step S11 and Step S12 are a sequence of processing steps to be inseparably executed. In Step S14, the relatively high speed operation processing device A51 is controlled so that the operation frequency of any device currently operating is elevated so as to commensurate with a time length or number of instructions previously set to a given value. When the operation frequency of the device is thus elevated so as to commensurate with the time length or number of instructions previously fixed, a whole system throughput can be improved in a relatively simplified manner.

FIG. 10 is a flow chart illustrating lock releasing (unlocking) processing steps by the content transfer device 71 in the group of apparatuses according to the exemplary embodiment 4. In Step S21, the locking information managed by the function locking unit 72 is updated to indicate the unlocking condition. In Step S22, the relatively high speed operation of the mobile terminal is reverted to a normal speed operation, and the lock releasing process ends. Step S21 is a part of a sequence of processing steps alongside Steps S11 and S12 to be inseparably executed.

When the lock releasing (unlocking) process is used, Step S4 can revert the high speed operation to a normal speed operation, meaning reverting the operation frequency to an original operation frequency by releasing the locking (unlocking) in Step S32 illustrated in FIG. 10, making it unnecessary to preset the time length or number of instructions. Then, the mobile terminal can be executed at a relatively high processing speed until the terminal mobile releases the lock object thereby acquired.

In Step S14, instructions and data to be accessed during the locking interval may be loaded on an instruction cache memory and a data cache memory. The cache memories are mounted in most of processors in a relatively simplified manner.

In Step S4, instructions and data to be accessed during the locking interval may be transferred to a device capable of high speed operability to be executed and accessed in the device. The device capable of high speed operability enables the processing speed to be accelerated. The device capable of high speed operability is not an always-on device but is used during the locking interval alone. As a result, power consumption can be reduced.

In the description of the present exemplary embodiment, the processing steps for obtaining the locking information managed by the function locking unit 72 and releasing the locking are executed by the mobile terminal A50 and the mobile terminal B60. Instead, the hard disc recorder 70 may obtain the locking information managed by the function locking unit 72 and release the locking when requested so by the mobile terminal A50 and the mobile terminal B60. In that case, the hard disc recorder 70 controls the relatively high speed operation processing device A51 of the mobile terminal A50 which succeeded in the locking. Therefore, the mobile terminal A50 is less burdened and reduced in weight as well.

The present invention is not necessarily limited to the present exemplary embodiment. In the description of the present exemplary embodiment, the group of apparatuses includes the mobile terminal A50, mobile terminal B60, and hard disc recorder 70. However, any apparatuses are used as far as the apparatuses have any sharable function or resource to be exclusively controlled between the apparatuses.

The present invention is also applicable to an apparatus wherein the apparatuses having any sharable function or resource to be exclusively controlled between the apparatuses are all combined.

As described so far, the present exemplary embodiment is technically advantageous in that any mobile terminal exclusively using the content transfer device 71 is capable of a relatively high speed operation. Therefore, an amount of time for using the content transfer device 71 can be reduced than in a normal speed operation, and a mobile terminal waiting for exclusive use of the content transfer device 71 can reduce its waiting time.

### Exemplary Embodiment 5

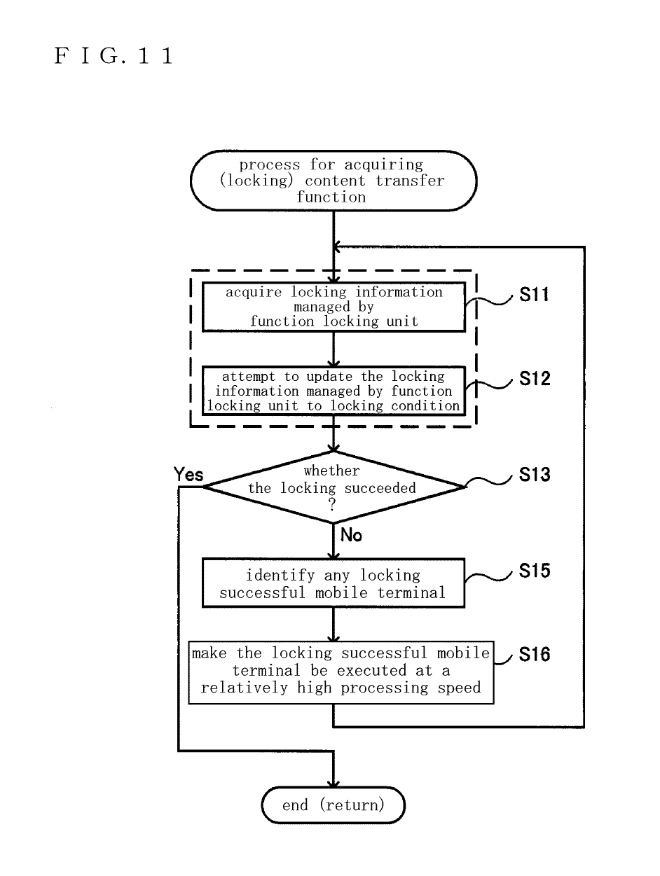

A group of apparatuses according to an exemplary embodiment 5 of the present invention is similar to the group of apparatuses according to the exemplary embodiment 4 illustrated in FIG. 8, therefore, description of the apparatuses is omitted. FIG. 11 is a flow chart illustrating lock acquiring (locking) processing steps by a content transfer device 71 in the apparatuses according to the exemplary embodiment 5. The present exemplary embodiment is technically characterized in that when the content transfer device 71 already being used is unavailable for any other mobile terminal, a mobile terminal currently using the content transfer device 71 is identified so that the content transfer device 71 used by the identified mobile terminal is operated at a relatively high processing speed in an interval during which the content transfer device 71 is used as compared to an interval during which the content transfer device 71 is not used.

When the mobile terminal A50 wants to use the content transfer device 71 before the mobile terminal B60, in Step S11, the mobile terminal A50 obtains the current locking information managed by the function locking unit 72. In Step S12, the mobile terminal A50 updates the locking information managed by the function locking unit 72 to indicate the locking condition. With the locking information obtained in Step S11 indicating that the unlocking condition, it is determined in Step S13 that the mobile terminal A50 succeeded in the locking, and the locking acquiring process ends.

When the mobile terminal B60 wants to use the content transfer device 71 after the mobile terminal A50, in Step S11, the mobile terminal B60 obtains the current locking information managed by the function locking unit 72. In Step S12, the mobile terminal B60 attempts to update the locking information managed by the function locking unit 72 to indicate the locking condition. However, the locking information already updated by the mobile terminal A50 to indicate the locking condition remains unchanged. With the locking information obtained in Step S11 indicating the locking condition, it is determined in Step S13 that the mobile terminal B60 failed the locking, and the mobile terminal B60 then returns to Step S15. In Step S15, the mobile terminal B60 identifies a mobile terminal which succeeded in the locking. Assuming that the mobile terminal A50 is identified as the mobile terminal which succeeded in the locking, information of the relatively high speed operation processing device A51 of the mobile terminal A50, and information of a program counter in execution and addresses accessed by the mobile terminal A50 can be obtained. In Step S16, the mobile terminal B60 controls the relatively high speed operation processing device A51 of the mobile terminal A50 to make the mobile terminal A51 be executed at a relatively high processing speed, and then returns to Step S11.

Step S11 and Step S12 are a sequence of processing steps to be inseparably executed. In Step S16, the relatively high speed operation processing device A51 elevates the operation frequency of any device currently operating in the other mobile terminal identified in Step S15 so that the other mobile terminal executes its process at a relatively high processing speed during the locking interval as compared to the locking invalid interval. The device operation frequency may be elevated so as to commensurate with the time length or number of instructions previously set to a given value.

The instructions to be executed and data to be accessed during the locking interval may be loaded on an instruction cache memory and a data cache memory. The instructions to be executed and data to be accessed loaded on the cache memories may commensurate with number of cache lines previously fixed to a given value.

Knowing beforehand there are only two mobile terminals to be connected; mobile terminal A50 and mobile terminal B60, Step S15 can identify the other mobile terminal as the locking successful mobile terminal.

When the function locking unit 72 succeeded in locking the content transfer device 71, information indicating which of the mobile terminals succeeded in the locking may be appended to the function locking unit 72, so that Step S15 reads the information to identify the successful mobile terminal.

An option is to provide a hardware device configured to automatically append information indicating which of the mobile terminals succeeded in the locking when the function locking unit 72 succeeded in locking the content transfer device 71.

In the description of the present exemplary embodiment, the processing steps for obtaining the locking information managed by the function locking unit 72 and releasing the locking are executed by the mobile terminal A50 and the mobile terminal B60. Instead, the hard disc recorder 70 may obtain the locking information managed by the function locking unit 72 and release the locking when requested so by the mobile terminal A50 and the mobile terminal B60. In that case, the hard disc recorder 70 controls the relatively high speed operation processing device A51 of the mobile terminal A50 which succeeded in locking the locking. This makes it unnecessary to provide a communication means for the mobile terminal B60 which failed the locking to control the relatively high speed operation processing device A51 of the mobile terminal A50 which succeeded in the locking.

The present invention is not necessarily limited to the present exemplary embodiment. In the description of the present exemplary embodiment, the group of apparatuses includes the mobile terminal A50, mobile terminal B60, and hard disc recorder 70. However, any apparatuses are used as far as the apparatuses have any sharable function or resource to be exclusively controlled between the apparatuses.

The present invention is also applicable to an apparatus wherein the apparatuses having any sharable function or resource to be exclusively controlled between the apparatuses are all combined.

As described so far, the present exemplary embodiment is technically characterized in that any mobile terminal exclusively using the content transfer device 71 is capable of a relatively high speed operation. Therefore, an amount of time for using the content transfer device 71 can be reduced than in a normal speed operation, and a mobile terminal waiting for exclusive use of the content transfer device 71 can reduce its waiting time. Further, a mobile terminal which failed the locking is responsible for making a mobile terminal which succeeded in the locking be operational at a relatively high processing speed, therefore, the mobile terminal which failed the locking busy waiting is not idling away time but plays such a productive role as making the locking successful mobile terminal operate at a relatively high processing speed

### Exemplary Embodiment 6

A group of apparatuses according to an exemplary embodiment 6 of the present invention is similar to the group of apparatuses according to the exemplary embodiment 4, therefore, description of the apparatuses is omitted.

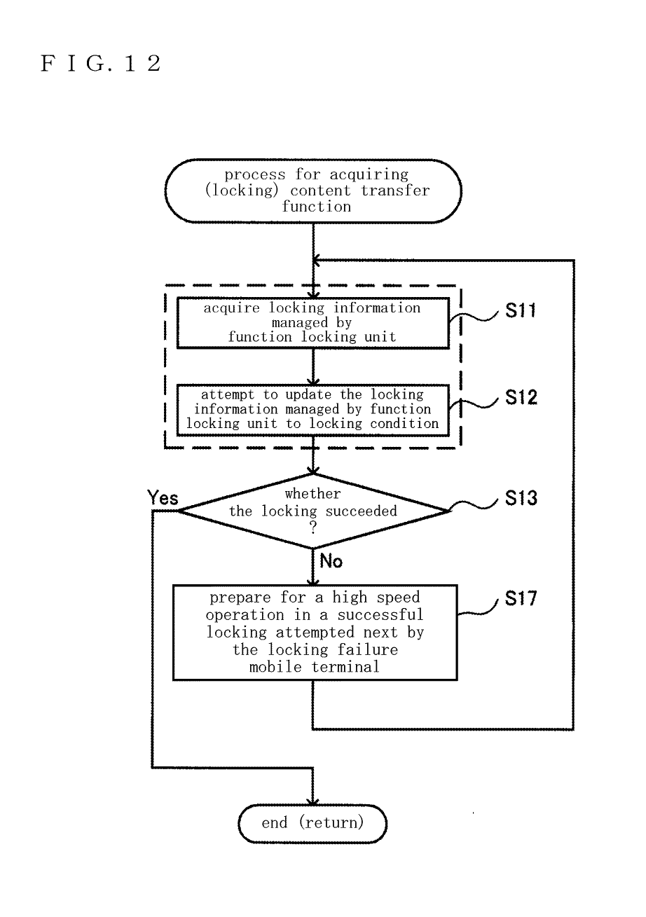

FIG. 12 is a flow chart illustrating lock acquiring (locking) processing steps by a content transfer device 71 in the apparatuses according to the exemplary embodiment 6. The present exemplary embodiment is technically characterized in that when the content transfer device 71 already being used and unavailable is made available for a mobile terminal, the mobile terminal is operated at a relatively high processing speed in an interval during which the content transfer device 71 is used as compared to an interval during which the content transfer device 71 is not used.

When the mobile terminal A50 wants to use the content transfer device 71 before the mobile terminal B60, in Step S11, the mobile terminal A50 obtains the current locking information managed by the function locking unit 72. In Step S12, the mobile terminal A50 updates the locking information managed by the function locking unit 72 to indicate the locking condition. With the locking information obtained n Step S11 indicating the unlocking condition, it is determined in Step S13 that the mobile terminal A50 succeeded in the locking, and the mobile terminal A50 ends the lock acquiring process.

When the mobile terminal B60 wants to use the content transfer device 71 after the mobile terminal A50, in Step S11, the mobile terminal B60 obtains the current locking information managed by the function locking unit 72. In Step S12, the mobile terminal B60 attempts to update the locking information managed by the function locking unit 72 to indicate the locking condition. However, the locking information already updated by the mobile terminal A50 to indicate the locking condition remains unchanged. With the locking information obtained in Step S11 indicating the locking condition, it is determined in Step S13 that the mobile terminal B60 failed the locking, and the mobile terminal B60 then proceeds to Step S17. In Step S17, the mobile terminal B60 controls its own relatively high speed operation processing device B61 to prepare itself for a relatively high speed operation as compared to the locking invalid interval when succeeding in a next attempt. Then, the mobile terminal B60 returns to Step S11.

Step S11 and Step S12 are a sequence of processing steps to be inseparably executed. In Step S17, information such as instructions to be executed and data to be accessed during the locking interval are loaded on an instruction cache memory and a data cache memory to be used after a next successful locking attempt to lock the lock object, so that the mobile terminal B60 can be executed at a relatively high processing speed.

The instructions to be executed and data to be accessed loaded the cache memories may commensurate with number of cache lines previously fixed to a given value. In the description of the present exemplary embodiment, the processing steps for obtaining the locking information managed by the function locking unit 72 and releasing the locking are executed by the mobile terminal A50 and the mobile terminal B60. Instead, the hard disc recorder 70 may obtain the locking information managed by the function locking unit 72 and release the locking when requested so by the mobile terminal A50 and the mobile terminal B60. In that case, the hard disc recorder 70 controls the relatively high speed operation processing device A51 of the mobile terminal B60 which failed the locking. Therefore, the mobile terminal B60 can be less burdened and reduced in weight as well.

The present invention is not necessarily limited to the present exemplary embodiment. In the description of the present exemplary embodiment, the group of apparatuses includes the mobile terminal A50, mobile terminal B60, and hard disc recorder 70. However, any apparatuses are used as far as the apparatuses have any sharable function or resource to be exclusively controlled between the apparatuses.

The present invention is also applicable to an apparatus wherein the apparatuses having any sharable function or resource to be exclusively controlled between the apparatuses are all combined.

As described so far, the present exemplary embodiment is technically advantageous in that when a mobile terminal which could not exclusively use the content transfer device 71 (failed the locking) is able to exclusively use the content transfer device 71 in a successful next attempt (succeeded in the locking), the mobile terminal operates at a relatively high processing speed, thereby reducing an amount of time for using the content transfer device 71 as compared to a normal speed operation. Further, the mobile terminal which failed the locking prepares itself for a successful next attempt, making it unnecessary to identify the mobile terminal which succeeded in the locking. The mobile terminal which failed the locking busy waiting is not idling away time but plays such a productive role as preparing itself for a higher speed operation.

The effect of the present invention described in the exemplary embodiments can be more expressly demonstrated in contrast to a comparative example. For example, when a process A with a high priority order wants to use a sharable resource in a multiprocessing system, a process C with a low priority order is already using the sharable resource. When a process B with an intermediate priority order is activated while the sharable resource is being used by the process C, the process B whose priority order is higher than that of the process C is prioritized over the process A regardless of its priority order lower than that of the process A. This technical problem, in which the original process priority order is ignored, is called priority inversion.

Conventionally, a technique called, priority inheritance, is employed to solve the technical problem. Describing the technique referring to the given example, when the process A with a high priority order attempts to use the sharable resource, the process C is upgraded to have a priority order equal to that of the process A while the process C is using the sharable resource. Then, the process C can continue to use the sharable resource even after the process B with an intermediate priority order is activated, and the process A is prioritized over the process B based on its original priority order.

Through the comparative example may appear to be similar to the present invention in that the process currently using the sharable resource is preferentially executed, the comparative example is different to the present invention in that a processing speed is not relatively increased. The priority inheritance technique is applied to a multiprocessing system wherein processes are executed by a processor in order to improve a real time performance. In contrast, the present invention focuses on the exclusion control technique in a multiprocessor, aiming at improving a throughput.

### INDUSTRIAL APPLICABILITY

The exclusion control method and the exclusion control system according to the present invention can contribute to improvement of a throughput in a system wherein it is necessary to wait for a lock object to be released while busy waiting when an attempt to acquire the lock object fails. The exclusion control method and the exclusion control system according to the present invention, therefore, are advantageous for an operating system designed for a multiprocessor.

### DESCRIPTION OF REFERENCE SYMBOLS

10 processor A
11 process A
20 processor B
21 process B
30 sharable resource
31 resource body
32 lock object
40 relatively high speed operation processing device
50 mobile terminal A
51 relatively high speed operation processing device A
60 mobile terminal B
61 relatively high speed operation processing device B
70 hard disc recorder
71 content transfer device
72 function locking unit

What is claimed is:

1. An exclusion control method for a multiprocessor having a lock object corresponding to a system resource, comprising:
a first step in which whether locking of the lock object by a process succeeds is determined when the process attempts to lock the lock object; and
a second step in which the process is executed at a relatively high processing speed in an interval during which the locking is valid as compared to an interval during which the locking is invalid when the first step determines that the locking succeeded, wherein
the first step and the second step are executed by a computer system including the multiprocessor.

2. An exclusion control method for a multiprocessor having a lock object corresponding to a system resource, comprising:
a first step in which whether a first locking of the lock object by a first process succeeds is determined when the first locking is attempted;
a second step in which a second process which already succeeded in locking the lock object is identified when the first step determines that the first locking failed; and
a third step in which the second process is executed at a relatively high processing speed in an interval during which a second locking of the lock object by the second process is valid as compared to an interval during which the second locking is invalid, wherein
the first step, the second step, and the third step are executed by a computer system including the multiprocessor.

3. An exclusion control method for a multiprocessor having a lock object corresponding to a system resource, comprising:
a first step in which whether a first locking of the lock object by a process succeeds is determined when first locking is attempted; and
a second step in which the process prepares for a relatively high speed operation in an interval during which a successful second locking of the lock object attempted next by the process is valid as compared to an interval during which the second locking is invalid when the first step determines that the first locking failed, wherein
the first step and the second step are executed by a computer system including the multiprocessor.

4. The exclusion control method as claimed in claim 1, further including a third step in which the relatively high speed operation of the process is reverted to a normal speed operation as soon as the lock object is unlocked when the locking valid interval is over.

5. The exclusion control method as claimed in claim 2, further including a fourth step in which the relatively high speed operation of the process is reverted to a normal speed operation as soon as the lock object is unlocked when the second locking valid interval is over.

6. The exclusion control method as claimed in claim 4, further including a fourth step in which gathering of an information in the locking valid interval is commenced when the first step determines that the locking succeeded, and the information gathering is quitted as soon as the lock object is unlocked when the locking valid interval is over.

7. The exclusion control method as claimed in claim 5, further including a fifth step in which gathering of an information in the locking valid interval is commenced when the first step determines that the locking succeeded, and the information gathering is quitted as soon as the lock object is unlocked when the locking valid interval is over.

8. The exclusion control method as claimed in claim 6, wherein a time length of the locking valid interval is measured and recorded in the fourth step.

9. The exclusion control method as claimed in claim 7, wherein a time length of the locking valid interval is measured and recorded in the fifth step.

10. The exclusion control method as claimed in claim 6, wherein a history of instructions carried out during the locking valid interval are gathered and recorded in the fourth step.

11. The exclusion control method as claimed in claim 7, wherein a history of instructions carried out during the locking valid interval are gathered and recorded in the fifth step.

12. The exclusion control method as claimed in claim 6, wherein a history of addresses of data accessed during the locking valid interval are gathered and recorded in the fourth step.

13. The exclusion control method as claimed in claim 7, wherein a history of addresses of data accessed during the locking valid interval are gathered and recorded in the fifth step.

14. The exclusion control method as claimed in claim 1, wherein an operation frequency of a device which runs the multiprocessor is elevated to execute the process at the relatively high processing speed in the second step.

15. The exclusion control method as claimed in claim 2, wherein an operation frequency of a device which runs the multiprocessor is elevated to execute the second process at the relatively high processing speed in the third step.

16. The exclusion control method as claimed in claim 1, wherein instructions to be carried out by the process during the locking valid interval are loaded on a cache memory to execute the process at the relatively high processing speed in the second step.

17. The exclusion control method as claimed in claim 2, wherein instructions to be carried out by the second process during the locking valid interval are loaded on a cache memory to execute the second process at the relatively high processing speed in the third step.

18. The exclusion control method as claimed in claim 1, wherein data to be accessed by the process during the locking valid interval is loaded on a cache memory to execute the process at the relatively high processing speed in the second step.

19. The exclusion control method as claimed in claim 2, wherein data to be accessed by the second process during the locking valid interval is loaded on a cache memory to execute the second process at the relatively high processing speed in the third step.

20. The exclusion control method as claimed in claim 1, wherein instructions to be carried out by the process during the locking valid interval are carried out by using a device capable of high speed operability to execute the process at the relatively high processing speed in the second step.

21. The exclusion control method as claimed in claim 1, wherein data to be accessed by the process during the locking valid interval are accessed by using a device capable of high speed operability to execute the process at the relatively high processing speed in the second step.

22. The exclusion control method as claimed in claim 1, wherein instructions to be carried out by the process during the locking valid interval are carried out in parallel by using a plurality of processors to execute the process at the relatively high processing speed in the second step.

23. The exclusion control method as claimed in claim 3, wherein instructions to be carried out by the process during the second locking valid interval are loaded on a cache memory to execute the process at the relatively high processing speed in the second step.

24. The exclusion control method as claimed in claim 3, wherein data to be accessed by the process during the locking valid interval is loaded on a cache memory to execute the process at the relatively high processing speed in the second step.

25. An exclusion control system for a multiprocessor having a lock object corresponding to a system resource, comprising:
a determination device configured to determine whether locking of the lock object by a process succeeds when the process attempts to lock the lock object; and
a relatively high speed operation processing device configured to make the process execute at a relatively high speed operation in an interval during which the locking is valid as compared to an interval during which the locking is invalid when the determination device determines that the locking succeeded.

26. An exclusion control system for a multiprocessor having a lock object corresponding to a system resource, comprising:
a determination device configured to determine whether a first locking of the lock object by a first process succeeds when the first process attempts to lock the lock object;
an identifying device configured to identify a second process which already succeeded in locking the lock object when the determination device determines that the first locking failed; and
a relatively high speed operation processing device configured to make the second process execute at a relatively high speed operation in an interval during which a second locking of the lock object by the second process is valid as compared to an interval during which the second locking is invalid.

27. An exclusion control system for a multiprocessor having a lock object corresponding to a system resource, comprising:
a determination device configured to determine whether a first locking of the lock object by a process succeeds when the first locking is attempted; and
a relatively high speed operation processing device configured to execute the process at a relatively high processing speed in an interval during which a successful second locking of the lock object attempted next by the process is valid as compared to an interval during which the second locking is invalid when the determination device determines that the first locking failed.

28. The exclusion control system as claimed in claim 25, further including a reverting device configured to revert the relatively high speed operation of the process to a normal speed operation as soon as the lock object is unlocked when the locking valid interval is over.

29. The exclusion control system as claimed in claim 26, further including a reverting device configured to revert the relatively high speed operation of the process to a normal speed operation as soon as the lock object is unlocked when the locking valid interval is over.

30. The exclusion control system as claimed in claim 28, further including a gathering device configured to commence gathering of an information in the locking valid interval when the determination device determines that the locking succeeded and quit the information gathering as soon as the lock object is unlocked when the locking valid interval is over.

31. The exclusion control system as claimed in claim 29, further including a gathering device configured to commence gathering of an information in the locking valid interval when the determination device determines that the locking succeeded and quit the information gathering as soon as the lock object is unlocked when the locking valid interval is over.

32. The exclusion control system as claimed in claim 30, wherein the gathering device measures and records a time length of the locking valid interval.

33. The exclusion control system as claimed in claim 31, wherein the gathering device measures and records a time length of the locking valid interval.

34. The exclusion control system as claimed in claim 30, wherein the gathering device gathers and records a history of instructions carried out during the locking valid interval.

35. The exclusion control system as claimed in claim 31, wherein the gathering device gathers and records a history of instructions carried out during the locking valid interval.

36. The exclusion control system as claimed in claim 30, wherein the gathering device gathers and records a history of addresses of data accessed during the locking valid interval.

37. The exclusion control system as claimed in claim 31, wherein the gathering device gathers and records a history of addresses of data accessed during the locking valid interval.

38. The exclusion control system as claimed in claim 25, wherein the relatively high speed operation processing device elevates an operation frequency of a device which runs the multiprocessor to execute the process at the relatively high processing speed.

39. The exclusion control system as claimed in claim 26, wherein the relatively high speed operation processing device elevates an operation frequency of a device which runs the multiprocessor to execute the process at the relatively high processing speed.

40. The exclusion control system as claimed in claim 25, wherein the relatively high speed operation processing device loads instructions to be carried out by the process during the locking valid interval on a cache memory to execute the process at the relatively high processing speed.

41. The exclusion control system as claimed in claim 26, wherein the relatively high speed operation processing device loads instructions to be carried out by the process during the locking valid interval on a cache memory to execute the process at the relatively high processing speed.

42. The exclusion control system as claimed in claim 25, wherein the relatively high speed operation processing device loads data to be accessed by the process during the locking valid interval on a cache memory to execute the process at the relatively high processing speed.

43. The exclusion control system as claimed in claim 26, wherein the relatively high speed operation processing device loads data to be accessed by the process during the locking valid interval on a cache memory to execute the process at the relatively high processing speed.

44. The exclusion control system as claimed in claim 25, wherein the relatively high speed operation processing device uses a device capable of high speed operability to carry out instructions to be carried out by the process during the locking valid interval so that the process is executed at the relatively high processing speed.

45. The exclusion control system as claimed in claim 25, wherein the relatively high speed operation processing device uses a device capable of high speed operability to access data to be accessed by the process during the locking valid interval so that the process is executed at the relatively high processing speed.

46. The exclusion control system as claimed in claim 25, wherein the relatively high speed operation processing device uses a plurality of processors to carry out in parallel instructions to be carried out by the process during the locking valid interval so that the process is executed at the relatively high processing speed.

47. The exclusion control system as claimed in claim 27, wherein the relatively high speed operation processing device loads instructions to be carried out by the process during the second locking valid interval on a cache memory so that the process is executed at the relatively high processing speed.

48. The exclusion control system as claimed in claim 27, wherein the relatively high speed operation processing device loads data to be accessed by the process during the locking valid interval on a cache memory so that the process is executed at the relatively high processing speed.

49. A hard disc recorder, comprising:
a data retention device configured to retain a content therein;
a content transfer device configured to transfer the content to an apparatus capable of communicating with the content transfer device;
an exclusion control device configured to control the content transfer device so that the content transfer device currently transferring the content is not used by any apparatus but the apparatus receiving the transferred content; and
a relatively high speed operation processing device configured to transmit an instruction to make the apparatus receiving the transferred content operate at a relatively high processing speed as compared to an interval during which the content is not transferred.

50. A mobile terminal, comprising:
an external apparatus utilization device configured to perform data communication with a function device of an external apparatus exclusively utilizable; and
a relatively high speed operation processing device configured to make the external apparatus utilization device operate at a relatively high processing speed in an interval during which the external apparatus utilization device is performing the data communication with the function device as compared to an interval during which the external apparatus utilization device is not performing the data communication with the function device.

51. A mobile terminal, comprising:
an external apparatus utilization device configured to perform data communication with a function device of an external apparatus exclusively utilizable;
an identifying device configured to identify another mobile terminal based on a data content obtained by the data communication when the function device is no longer available because the function device is already performing the data communication with the another mobile terminal; and
a relatively high speed operation processing device configured to transmit an instruction to make the another mobile terminal operate at a relatively high processing speed in an interval during which the another terminal is performing the data communication with the function device as compared to an interval during which the another terminal is not performing the data communication with the function device.

52. A mobile terminal, comprising:
an external apparatus utilization device configured to perform data communication with a function device of an external apparatus exclusively utilizable; and
a relatively high speed operation processing device configured to make the external apparatus utilization device prepare for a relatively high speed operation in an interval during which the external apparatus utilization device is performing the data communication with the function device as compared to an interval during which the external apparatus utilization device is not performing the data communication with the function device when the data communication currently unavailable between the external apparatus utilization device and the function device is made available therebetween.
